(19) United States
(12) Patent Application Publication
(10) Pub. No.: US 2026/0329663 A1
(43) Pub. Date: Oct. 22, 2026

(54) SYSTEMS AND METHODS FOR OPERATING A MODULAR COMPUTING SYSTEM

(71) Applicant: Quanta Computer Inc., Taoyuan City (TW)

(72) Inventors: Yu-Kai WANG, Taoyuan City (TW); Sheng-Yuan ZENG, Taoyuan City (TW); Yan-Rong GUO, Taoyuan City (TW)

(21) Appl. No.: 19/181,220

(22) Filed: Apr. 16, 2025

(51) Int. Cl. G06F 9/50; G06F 9/445; G06F 11/14; G06F 11/34

(52) U.S. Cl. CPC G06F 9/5077; G06F 9/44505; G06F 11/1417; G06F 11/3476

(57) ABSTRACT

A computing system includes a BMC, a plurality of processing units electrically connected to the BMC, and a BIOS chip storing BIOS firmware. During a start-up process of the computing system, one or more of the plurality of processing units is configured to execute the BIOS firmware to collect processing unit information. The one or more of the plurality of processing units is further configured to execute the BIOS firmware to determine, based at least in part on the processing unit information, a current configuration of the plurality of processing units. The one or more of the plurality of processing units is further configured to execute the BIOS firmware to partition resources of the computing system among the plurality of processing units based at least in part on the current configuration of the plurality of processing units.

### FIELD OF THE INVENTION

The present invention relates generally to systems and methods for partitioning resources of a computing system, and more specifically, to a BIOS that can partition resources of a modular computing system having a variable number of processor units.

### BACKGROUND OF THE INVENTION

High-end servers and other computing systems may include multiple processing units for performing complex tasks. These processing units may be mounted on multiple different circuit boards (e.g., motherboards, processing unit boards, etc.). Computing systems originally manufactured for a specific number of processing units and processing unit boards can function properly with standard BIOS firmware. However, some computing systems are modular, and can be formed from multiple processing unit boards not originally intended to be used together. In such computing systems, standard BIOS firmware may have difficulty in recognizing the configuration of the processing units and operating the computing system. Thus, new systems and methods for operating modular computer systems are needed.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to a first implementation of the present disclosure, a computing system includes a baseboard management controller (BMC), a plurality of processing units electrically connected to the BMC, and a basic input output system (BIOS) chip having BIOS firmware stored thereon. During a start-up process of the computing system, one or more of the plurality of processing units is configured to execute the BIOS firmware to collect processing unit information. The one or more of the plurality of processing units is further configured to execute the BIOS firmware to determine, based at least in part on the processing unit information, a current configuration of the plurality of processing units. The one or more of the plurality of processing units is further configured to execute the BIOS firmware to partition resources of the computing system among the plurality of processing units based at least in part on the current configuration of the plurality of processing units.

In some aspects of the first implementation, the processing unit information includes a number of the plurality of processing units, an identification of a plurality of sockets of the computing system that each of the plurality of processing units is electrically connected to, a number of processing unit boards upon which the plurality of processing units is distributed, or any combination thereof.

In some aspects of the first implementation, the resources of the computing system include at least (i) a plurality of memory devices, (ii) one or more chipsets, (iii) one or more peripheral devices, (iv) one or more bus segments electrically connecting the plurality of processing units to the plurality of memory devices, the one or more chipsets, and the one or more peripheral devices, or (v) any combination of (i)-(iv).

In some aspects of the first implementation, partitioning the one or more memory devices of the computing system includes performing memory-mapped input/output to assign addressable space of the one or more memory devices to each of the plurality of processing units.

In some aspects of the first implementation, in response to one of the plurality of processing units becoming undetectable during operation of the computing system, one or more of the other processing units is configured to execute the BIOS firmware to cause addressable space assigned to the undetectable processing unit to be reassigned to a remainder of the plurality of processing units.

In some aspects of the first implementation, partitioning the one or more bus segments includes assigning each of the one or more bus segments to one or more of the plurality of processing units.

In some aspects of the first implementation, in response to one of the plurality of processing units becoming undetectable during operation of the computing system, one or more of the other processing units is configured to execute the BIOS firmware to cause the bus segments assigned to the undetectable processing unit to be reassigned to a remainder of the plurality of processing units.

In some aspects of the first implementation, the BIOS firmware stored on the BIOS chip includes a resource table. The resource table defines a partition plan of the resources of the computing system for each of a plurality of different configurations of the plurality of processing units.

In some aspects of the first implementation, partitioning the resources of the computing system includes partitioning the resources according to a first partition plan in response to the current configuration of the plurality of processing units being a first configuration, and partitioning the resources according to a second partition plan in response to the current configuration of the plurality of processing units being a second configuration. The second configuration includes (i) a different number of processing units than the first configuration, (ii) an identical number of processing units as the first configuration but a different set of sockets to which the processing units are electrically connected to, or (iii) an identical number of processing units as the first configuration but a different number of processing unit boards upon which the processing units are mounted.

In some aspects of the first implementation, partitioning the resources of the computing system includes partitioning the resources according to a first partition plan based on the current configuration of the plurality of processing units. In response to one of the plurality of processing units becoming undetectable during operation of the computing system, one or more other processing units are configured to execute the BIOS firmware to cause the resources of the computing system to be partitioned according to a second partition plan based on an updated configuration of the plurality of processing units that does not include the undetectable processing unit. The second partition plan is different than the first partition plan.

In some aspects of the first implementation, during a first portion of the start-up process, the one or more of the plurality of processing units is configured to execute the BIOS firmware to receive a first indication from the BMC that a variable number of processing units are electrically connected to the BMC, and during a second portion of the start-up process, the one or more of the plurality of processing units is configured to execute the BIOS firmware to collect the processing unit information, determine the current configuration of the plurality of processing units, and partition the resources of the computing system.

In some aspects of the first implementation, during the first portion of the start-up process, the one or more of the plurality of processing units is configured to execute the BIOS firmware to perform a power-on self-test (POST) routine.

In some aspects of the first implementation, the computing system further includes a plurality of sockets and a plurality of interconnects electrically connecting each socket to at least one other socket. Each of the plurality of processing units is electrically connected to one of the plurality of sockets. In response to one of the plurality of processing units becoming undetectable during operation of the computing system, one or more of the other processing units is configured to execute the BIOS firmware to determine which socket the undetectable processing unit is electrically connected to. The one or more of the other processing units is further configured to execute the BIOS firmware to determine if any one or more of the plurality of interconnects electrically connected to the socket of the undetectable processing unit is faulty. The one or more of the other processing units is further configured to execute the BIOS firmware to store an event log in a memory device of the computing system. The event log includes an identity of the socket of the undetectable processing unit and an identity of any faulty interconnects electrically connected to the socket of the undetectable processing unit.

In a second implementation of the present disclosure, a method of operating a computing system that includes a baseboard management controller (BMC), a plurality of processing units electrically connected to the BMC, and a basic input output system (BIOS) chip having BIOS firmware stored thereon is disclosed. The method includes collecting processing unit. The method further includes determining, based at least in part on the processing unit information, a current configuration of the plurality of processing units. The method further includes partitioning resources of the computing system among the plurality of processing units based at least in part on the current configuration of the plurality of processing units.

In some aspects of the second implementation, the processing unit information includes a number of the plurality of processing units, an identification of a plurality of sockets of the computing system that each of the plurality of processing units is electrically connected to, a number of processing unit boards upon which the plurality of processing units is distributed, or any combination thereof.

In some aspects of the second implementation, the resources of the computing system include at least (i) a plurality of memory devices, (ii) one or more chipsets, (iii) one or more peripheral devices, (iv) one or more bus segments electrically connecting the plurality of processing units to the plurality of memory devices, the one or more chipsets, and the one or more peripheral devices, or (v) any combination of (i)-(iv).

In some aspects of the second implementation, the BIOS firmware stored on the BIOS chip includes a resource table. The resource table defines a partition plan of the resources of the computing system for each of a plurality of different configurations of the plurality of processing units.

In some aspects of the second implementation, partitioning the resources of the computing system includes partitioning the resources according to a first partition plan in response to the current configuration of the plurality of processing units being a first configuration, and partitioning the resources according to a second partition plan in response to the current configuration of the plurality of processing units being a second configuration. The second configuration includes (i) a different number of processing units than the first configuration, (ii) an identical number of processing units as the first configuration but a different set of sockets to which the processing units are electrically connected to, or (iii) an identical number of processing units as the first configuration but a different number of processing unit boards upon which the processing units are mounted.

In some aspects of the second implementation, partitioning the resources of the computing system includes partitioning the resources according to a first partition plan based on a current configuration of the plurality of processing units. The method further includes determining that one of the plurality of processing units is undetectable. The method further includes determining an updated configuration of the plurality of processing units that does not include the undetectable processing unit. The method further includes partitioning the resources of the computing system according to a second partition plan based on the updated configuration of the plurality of processing units. The second partition plan is different than the first partition plan.

In some aspects of the second implementation, the computing system includes a plurality of sockets and a plurality of interconnects electrically connecting each socket to at least one other socket. Each of the plurality of processing units is electrically connected to one of the plurality of sockets. The method further includes, in response to one of the plurality of processing units becoming undetectable during operation of the computing system, determining which socket the undetectable processing unit is electrically connected to. The method further includes determining if any of the plurality of interconnects electrically connected to the undetectable processing unit or the socket of the undetectable processing unit are faulty. The method further includes storing an event log in a memory device of the computing system that includes an identity of the socket of the undetectable processing unit and an identity of any faulty interconnects electrically connected to the undetectable processing unit, the socket of the undetectable processing unit, or both.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a block diagram of a modular computing system having a variable number of processing units, according to certain aspects of the present disclosure.

FIG. 2 is a flowchart of a method of partitioning resources of the modular computing system of FIG. 1, according to certain aspects of the present disclosure.

FIGS. 3A-3B are example resource tables that are used by the example method of portioning resources, according to certain aspects of the present disclosure.

FIGS. 4A-4B are tables of example bus assignments for different configurations, according to certain aspects of the present disclosure.

FIGS. 4C-4G are tables of example MMIO-L resource assignments for different configuration, according to certain aspects of the present disclosure.

### DETAILED DESCRIPTION

Various embodiments are described with reference to the attached figures, where like reference numerals are used throughout the figures to designate similar or equivalent elements. Each reference numeral identifies the figure in which the reference numeral first appears, based on the first digit (for three-digit reference numerals) or the first two digits (for four-digit reference numerals) corresponding to the figure numeral of the figure. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

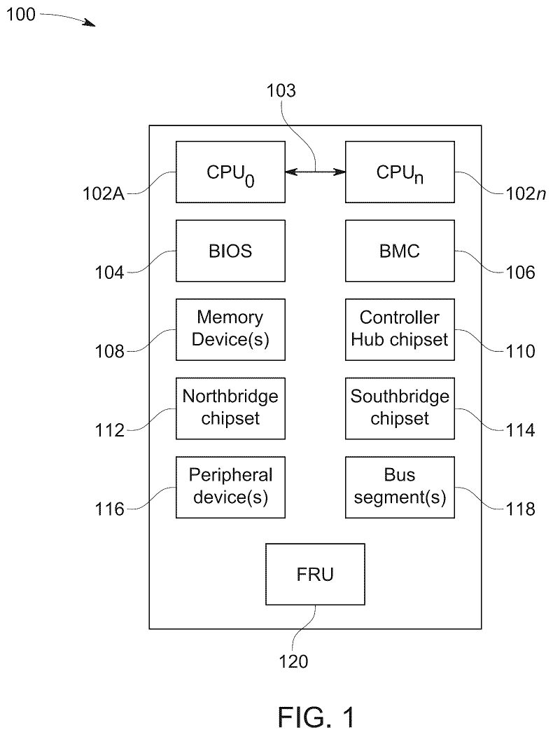

FIG. 1 illustrates a block diagram of a modular multi-CPU computing system 100 according to certain aspects of the present disclosure. In some implementations, the computing system 100 is a server, but the principles disclosed herein may be incorporated into any computing system having one or more of the components described herein. The computing system 100 includes processing units 102A-102n. In the illustrated implementation, only processing unit 102A and processing unit 102n are explicitly shown. However, it is understood that processing unit 102A and processing unit 102n represent the first and last processing unit of generally any plurality of processing units. For example, processing units 102A-102n could include two processing units, four processing units, eight processing units, sixteen processing units, thirty-two processing units, etc. In general, the number of the processing units in the computing system 100 is not a static number. Rather, the computing system 100 is modular in the sense that the actual number of processing units is variable depending on the specific application for which the computing system 100 is being used.

Processing unit 102A is labeled as CPU₀ and CPUₙ, generally referring to central processing unit. However, the processing units may generally include any suitable type of processing unit, such as a graphics processing unit (GPU), a microcontroller, other types of coprocessors (e.g., neural processing units, digital signal processing units, field-programmable gate arrays, etc.), and/or any other suitable processing unit. The processing units 102A-102n will generally be mounted on one or more processing unit boards, along with any other supporting components. In some implementations, each one of the processing units 102A-102n is mounted on its own respective processing unit board. In other implementations, at least one of the processing unit boards has multiple processing units mounted thereon. For example, the computing system 100 may include processing unit boards that each include two processing units mounted thereon.

The computing system 100 further includes one or processor interconnects 103, represented in FIG. 1 by the double arrow extending between processing unit 102A and processing unit 102n. In general, the computing system 100 will include at least one processor interconnect between two processing units that can be used for data transfer between the two processing units. In some implementations, the processor interconnect 103 between two individual processing units is formed from a plurality of individual lanes. The processor interconnect between two processing units mounted on the same processing unit board will often be physically formed in that processing unit board itself. However, processing units mounted on different processing unit boards may also be connected via one or more processor interconnects 103. In these implementations, the computing system 100 may include additional boards that couple together processing units of different processing boards (e.g., a front bridge board, a rear bridge board, a midplane board, a backplane board, etc.). In general, the computing system 100 will include a plurality of sockets mounted on one or more boards, where each of the processing units 102A-102n is electrically connected to a distinct one of the sockets. The processor interconnect 103 between two processing units on separate boards will the be formed both in the two sockets that those two processing units are electrically connected to, and the board on which the two sockets are mounted.

The computing system 100 further includes a BIOS 104. The BIOS 104 is a memory device that stores basic input output system (BIOS) firmware. As used herein, the term “BIOS 104” may refer to both the memory device itself, and the firmware stored thereon. The BIOS 104 can be any suitable memory device, such as a random access memory (RAM) chip, a dynamic RAM (DRAM) chip, a static RAM (SRAM) chip, a read-only memory (ROM) chip, a programmable ROM (PROM) chip, an erasable PROM (EPROM) chip, an electrically erasable PROM (EEPROM) chip, a flash memory chip (e.g., NOR flash, NAND flash, etc.), a synchronous DRAM (SDRAM) chip, a double data rate SDRAM (DDR SDRAM) chip, a hard drive, or any other suitable memory device.

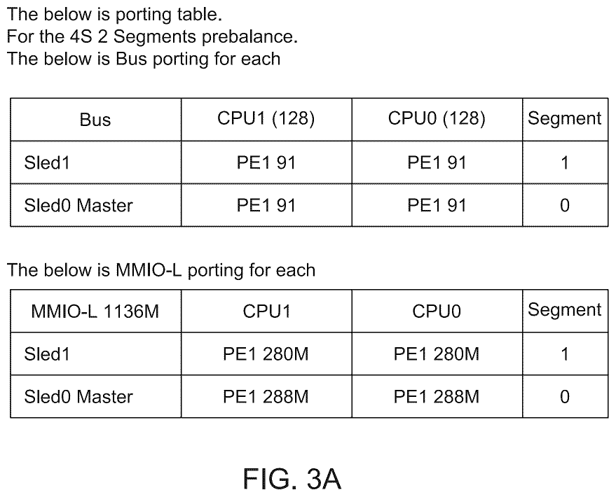

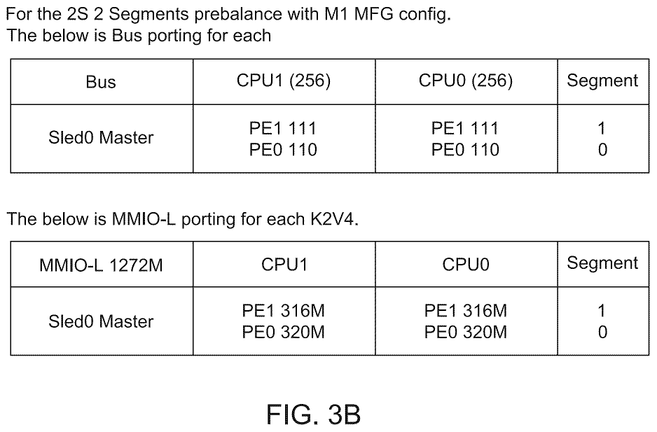

The BIOS firmware can be executed to perform a variety of different basic tasks, including initializing and testing various components of the computing system 100 when the computing system 100 is powered on (generally referred to as executing the power-on self-test (POST) routine); loading the bootloader from a separate memory device (generally a hard drive or flash storage); partitioning resources of the computing system 100 among the processing units 102A-102n, etc. The BIOS firmware may be executed by any one or more of the processing units 102A-102n, and/or by any other processor/controller of the computing system 100. Moreover, while this start-up firmware is referred to as BIOS firmware, the BIOS chip 104 may generally include any suitable firmware, including firmware complying with the Unified Extensible Firmware Interface (UEFI) standard. As is discussed further herein, the BIOS firmware is designed to function properly with different numbers of processing units and/or processing unit boards. In some implementations, the BIOS firmware includes a resource table that defines a partition plan for resources of the computing system 100 for each of a plurality of different processing unit configurations. Example resource tables are shown in FIGS. 3A-3B as are detailed below.

The computing system 100 further includes a baseboard management controller (BMC) 106, which is a specialized controller for managing operations of the computing system 100, and generally includes its own processing unit and memory device. The BMC 106 can allow for remote monitoring of various different components of the computing system 100. In some implementations, the BMC 106 is used to implement the Intelligent Platform Management Interface (IPMI) standard.

The computing system 100 may further include one or more memory devices 108. The one or more memory devices 108 may include any suitable memory device, including those discussed herein with respect to the BIOS chip 104. The one or more memory devices 108 will generally include memory modules used by the processing units 102A-102n, which may be in the form of dual in-line memory modules (DIMMs) that include individual memory chips (e.g., SDRAM chips, DDR SDRAM chips, etc.). The computing system 100 may further include a variety of chipsets that can be used to perform a variety of different computing tasks. In the illustrated implementation, possible chipsets include a controller hub chipset 110 (common examples of which include a platform controller hub or PCH, and a fusion controller hub or FCH), a Northbridge chipset 112, and a Southbridge chipset 114. The chipsets could also include field-programmable gate arrays (FPGAs), application-specific integrated circuits (ASICs), memory controllers, I/O controllers, etc.

The computing system 100 may further include a variety of peripheral devices 116 that can be connected to the processing units 102A-102n, the BIOS chip 104, the BMC 106, and/or any other component of the computing system 100. These peripheral devices 116 can generally include any peripheral device that may be connected (internally or externally) to the computing system 100, and may include, for example: fan modules; expansion cards, such as graphics cards, capture cards, sound cards, other expansion cards, etc.; hard disk drives; sold state drives; USB flash drives; network interface controllers or cards (NICs); I/O ports including USB ports, Ethernet ports, other network ports, HDMI ports, DVI ports, VGA ports, etc.; input devices including mice, keyboards, controllers, microphones, webcams, scanners, etc.; output devices such as monitors, printers, headphones, speakers, etc.; and other circuit boards such as daughterboards.

The computing system 100 further includes one or bus segments 118. The bus segments 118 electrically connect the processing units 102A-102n to generally any of the other components of the computing system 100, including the BIOS chip 104; the BMC 106; the memory devices 108; the chipsets 110, 112, and 114; and the peripheral devices 116.

The computing system 100 may further include a field replaceable unit (FRU) 120 that is used to indicate to the BIOS 104 that the computing system 100 is a modular computing system with a variable number of processing units/processing unit configurations. The FRU 120 will generally be connected to the BMC 106.

In this example, the FRU 120 may be used to determine platform configurations for the system under test. The platform configurations include an ODM name, product name, and unique serial number. The configuration is null when the main board is under SMT process. Before a mother board (e.g., M1) starts to run a MFG test, the operators will use ICT tools to flash the FRU information. In this example, the BIOS 104 will use the ipmitool cmd to send raw data to the BMC 106. The BMC 106 will then report the FRU information to the BIOS 104. During POST time, the FRU product name configuration allows the BIOS 104 to determine the SKU since different SKUs have different hardware configurations and port. If the FRU product name configuration is incorrect, it causes a BIOS POST hang code issue. Using the current known process, if a 4S module is using the FRU product name for an 8S module, a hang code issue will occur. Without the ICT tool to update the FRU product name, the product name configuration is empty. This also causes boot failure during POST due to the mismatched configuration on the BIOS boot policy.

With the present example method, all modular projects such as 2S/4S/8S/16S/32S may have the same FRU product name. The same product name supports BIOS POST because the numbers of sockets is used as SKU determinations. This can significantly enhance MFG process on different mother boards (e.g., M1 or M3), spare part replacements, demand switching on different modular SKUs, and failure on a degraded configuration, e.g., 8S to 4S or 4S to 2S.

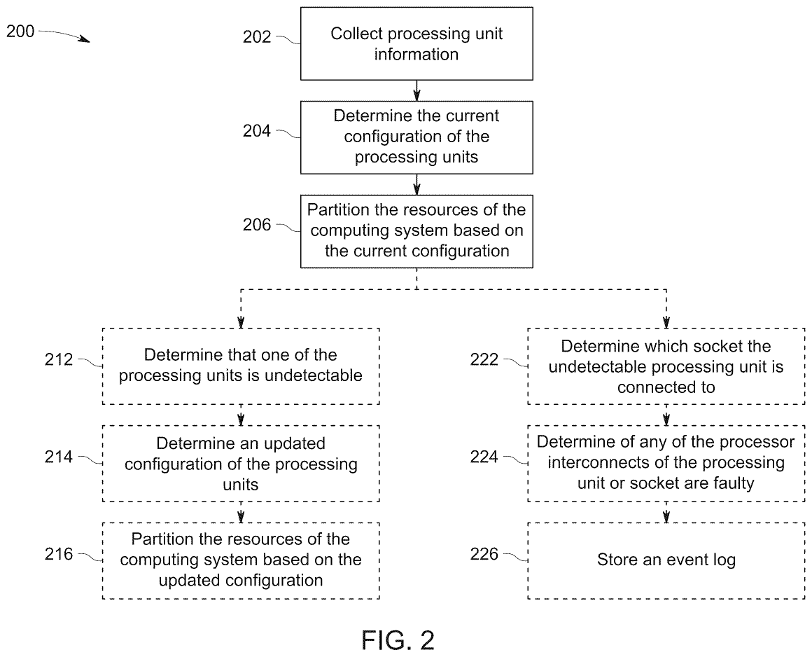

FIG. 2 shows a flowchart of a method 200 for operating the computing system 100 (e.g., for operating a modular computing system with a variable number of processing units). For computing systems that are intended to always have a set number of processing units (e.g., only two processing units, only four processing units, etc.), the manufacture and setup of the computing device is generally straightforward. Specifically, the processing unit boards with the processing units are generally designed specifically to be used with a computing system having a set number of processing units, and the BIOS firmware on the BIOS chip will be designed to partition resources of the computing systems among the set number of processing units. Thus, a computing system with four processing units have a single processing unit board specifically designed to be used with the four processing units.

However, modular computing systems (such as computing system 100), will often use multiple processing unit boards designed for smaller numbers of processing units to achieve a computing system with a larger number of processing units. For example, to achieve four total processing units, the modular computing system 100 could utilize two processing unit boards each having two processing units, which were each originally designed to be used in a computing system with only two processing units. In another example, to achieve eight total processing units, the modular computing system 100 could utilize (i) four processing unit boards, each with two processing units and originally designed to be used in a computing system with only two processing units, or (ii) two processing unit boards, each with four processing units and originally designed to be used in a computing system with only four processing units. In any of these examples, a BIOS that was designed for a specific processing unit configuration (e.g., a single one of the processing unit boards with two processing units) will generally not function properly with multiple of the processing unit boards. However, because the BIOS 104 of the computing system 100 includes a resource table that defines the partition plan for different processor unit configurations, the BIOS 104 will function properly.

Step 202 of method 200 includes collecting processing unit information. In general, step 202 may take place when the computing system 100 is initially powered on or restarted. One or more of the processing units 102A-102n executes the BIOS firmware 104 to cause the processing unit to collect processing unit information, which will generally include communicating with other processing units and/or processing unit boards. The processing unit executing the BIOS firmware 104 may be referred to as the master/primary processing unit, or a processing unit of a master/primary processing unit board. The processing unit information may be stored in one of the memory devices 108, a memory device of one of the processing units 102A-102n, the BIOS 104 (e.g., the memory device storing the BIOS firmware), a memory device of the peripheral devices 116 (e.g., a hard disk drive, a solid state drive, etc.), or in any other suitable location. The processing unit information will generally include any necessary information related to the processing units 102A-102n that are currently being used. For example, as noted herein, each of the processing units 102A-102n will be electrically connected to one of the sockets of the computing system 100. The processing unit information may thus include information associated with the specific number of the processing units 102A-102n, information associated with an identification of socket of the computing system 100 that is electrically connected to one of the processing units 102A-102n, information associated with the number of processing unit boards the processing units 102A-102n are mounted on, other information, or any combination thereof.

For example, if the computing system 100 includes eight sockets (e.g., sockets 0-7), the processing unit information may indicate that the computing system 100 includes four processing units electrically connected to sockets 0, 1, 2, and 3. In another example (a degraded 4S), if the computing system 100 includes eight sockets, the processing unit information may indicate that the computing system 100 includes four processing units electrically connected to sockets 0, 4, 5, and 7. In a further example, if the computing system 100 includes eight sockets, the processing unit information may indicate that the computing system 100 includes eight processing units electrically connected to sockets 0-7.

Step 204 of method 200 includes determining the current configuration of the plurality of processing units 102A-102n of the computing system 100 based at least in part on the processing unit information. In general, a given configuration of the plurality of processing units 102A-102n will include at least how many processing units are electrically connected to the computing system 100, and which sockets those processing units are plugged into.

Step 206 of method 200 includes partitioning resources of the computing system 100 among the plurality of processing units 102A-102n based at least in part on the current configuration of the plurality of processing units 102A-102n. The resources of the computing system 100 generally includes a wide variety of devices and components, including one or more memory devices (e.g., memory devices 108), one or more chipsets (e.g., the controller hub chipset 110, the Northbridge chipset 112, the Southbridge chipset 114, etc.), one or more peripheral devices (e.g., the peripheral devices 116), bus segments that electrically connected the processing units 102A-102n to these resources (e.g., the one or more bus segments 118), other resources, and any combinations thereof.

As noted herein, the BIOS 104 includes a resource table stored thereon that defines the partition plan for a variety of different configurations of the plurality of processing units 102A-102n. The partition plan for each configuration will indicate how the various resources of the computing system 100 are to be divided among the processing units of each configuration. In general, each configuration of the processing units 102A-102n will have its own respective partition plan. For example, the current configuration of the 102A-102n as determined in step 204 being a first configuration may result in partitioning the resources according to a first partition plan, while the current configuration being a second configuration will generally result in partitioning the resources according to a second partition plan that is different than the first partition plan when the second configuration is different than the first configuration.

The second configuration being different than the first configuration may occur in a variety of different scenarios. For example, the second configuration may be considered to be different than the first configuration when the second configuration includes a different number of processing units compared to the first configuration. In another example, the second configuration may be considered to be different than the first configuration when the second configuration includes the same number of processing units but a different set of sockets. In a further example, the second configuration may be considered to be different than the first configuration when the second configuration includes the same number of processing units compared to the first configuration but a different number of processing unit boards.

In some implementations however, there may be some configurations that are different from each other, but have the same partition plan defined in the resource table of the bios 104. For example, in some implementations, all configurations with four processing units may have the same partition plan, even if those four processing units are electrically connected to different sockets and/or mounted on different processing unit boards.

In some implementations, partitioning the resources of the computing system 100 includes performing memory-mapped input/output for all of the memory devices 108. This assigns addressable space of the memory devices 108 to each of the processing units 102A-102n, and determines the addressable space that is used to access/operate any of the peripheral devices 116. In some implementations, partitioning the resources of the computing system 100 additionally or alternatively includes assigning each of the bus segments 118 to one or more of the plurality of processing units 102A-102n.

In many computing systems, during a first portion of the start-up process after the computing system is powered on, the BIOS performs the POST routine, which can be used to test various components of the computing systems, and set various parameters of the computing system, such as GPIO pin configurations, transmission parameters of the processor interconnects, etc. The BIOS often receives from the BMC an indication of the identity of the computing system (e.g., the SKU, or product name) during the first portion of the start-up routine. In computing system 100, it is not yet necessary for the BIOS 104 to know the specific configuration of the plurality of processing units 102A-102n yet. However, the BIOS 104 may still hang during the POST routine if it does know that the computing system 100 is a modular computing system with a variable number of processing units/processing unit boards. Thus, in some cases, method 200 can include receiving an indication from the BMC 106 that the computing system 100 is a modular computing system with a variable number of processing units and/or processing unit boards. This indication, combined with the processing unit information collected in step 202, allows the processing unit configuration to be determined and the resources to be partitioned. In some implementations, this indication is received during the first portion of the start-up process (when the POST routine is performed).

As noted herein, the computing system 100 may include an FRU 120 coupled to the BMC 106. The FRU 120 can be configured to cause this indication (which effectively functions as the product name of the computing system 100) to be sent from the BMC 106 to the BIOS 104 during the first portion of the start-up process. By using the FRU 120, the BIOS 104 is allowed to function properly with the modular computing system 100 without having to make any changes to the BMC 106 during manufacture.

This may be employed to facilitate UBA training and KTI early training. UBA training is used for GPIO, TxEQ tuning for Ultra Path Interconnect (UPI), PCIe bifurcation, and USB porting. These UBA configurations all depend on the hardware design. For example, one SKU may set a GPIO to GPI while another KSU may set the GPIO to GPO. This will cause hang code issues due to the hardware design as the BIOS cannot re-purpose the GPIO to GPO thus causing conflicts. In a UBA training example, a 2S module may have a UBA design based on a first hardware design, and the 8S module may have another UBA design based on another hardware design. Those configurations cannot be mixed up. Thus, the specific modular design FRU product name, which is different from the other non-modular design FRU product name is required. In the UBA training stage, if the modular design mother board uses the FRU product name of the non-modular design, a hang code will be caused in the UBA training stage.

KTI early training includes configuring a CPU and the training of the CPU, i.e., for UPI. In this stage, the firmware like pcode of the CPU will be based on hardware straps for 2S/4S/8S boot. This means that even if the CPU is installed on an 8S module, hardware straps can only let the pcode use a 2S module to boot. The BIOS only knows the numbers of CPUs based on pcode (CPU firmware) reporting. Therefore, if the hardware installs an 8S module and the hardware straps ports them to an 8S boot, the BIOS will know the hardware as an 8S boot if there is not any UPI failure causing KTI degradation. For the wording “KTI degradation,” the hardware provides 8 CPUs for the BIOS to train for an 8S boot, but due to some hardware failure on UPI, the BIOS needs to disable some UPI ports and CPUs to make it compatible to the Intel KTI training model. Thus, how the BIOS determines the numbers of sockets is critical after KTI training. If the number of sockets in the 8S example is degraded to 4S, the BIOS should use the 4S resources table instead of 8S table. Using the mismatched resources table also causes boot failure. The example method allows the BIOS to know the number of sockets to port the resources table instead of automatically using a configuration to set it up by chance.

In some implementations, the computing system 100 is configured to re-partition resources in real-time if one of the processing units 102A-102n becomes undetectable. A processing unit may become undetectable due to a fault with the processing unit, the processing unit board upon which the processing unit is mounted, the socket to which the processing unit is electrically connected, any processor interconnects connecting the processing unit to other processing units, etc. In these implementation, method 200 may further include optional steps 212, 214, and 216.

Step 212 includes determining that one of the processing units 102A-102n is undetectable. In some implementations, step 212 includes receiving an indication from the BMC 106 that one of the processing units 102A-102n has become undetectable. In other implementations, the BIOS 104 (and/or the processing units that are executing the BIOS firmware 104) determines directly that one of the processing units 102A-102n has become undetectable.

Step 214 includes determining the updated configuration of the processing units, which may include receiving updated processing unit information from the BMC 106, and determining the updated configuration of the remaining processing units 102A-102n. Step 216 includes repartitioning the resources of the computing system 100 based on the updated configuration of the plurality of processing units 102A-102n. This process thus allows for the resources of the computing system 100 originally assigned to the now undetectable processing unit to be reassigned to and usable by different processing units, instead of going unused.

In some implementations, repartitioning the resources of the computing system 100 after one of the processing units 102A-102n has become undetectable includes reassigning bus segments 118 originally assigned to the undetectable one of the processing units 102A-102n among the remainder of the processing units 102A-102n. In some implementations, repartitioning the resources of the computing system 100 after one of the processing units 102A-102n has become undetectable includes reassigning addressable space of the memory devices 108 originally assigned to the undetectable one of the plurality of processing units 102A-102n among the remainder of the plurality of processing units 102A-102n, so that no addressable space is unused.

In some implementations, the BIOS firmware 104 can be executed to perform debugging after one of the processing units 102A-102n has become undetectable. Because the BIOS 102 is able to accommodate processing units becoming undetectable and to re-partition resources in real-time, the BIOS 104 is able to perform a more detailed debugging process.

In these implementations, method 200 may include optional steps 222, 224, and 226. Step 222 includes determining which socket the undetectable one of the processing units 102A-102n is electrically connected to. Step 224 includes determining if any processor interconnects that are electrically connected to the undetectable processing unit and/or the socket of the undetectable processing unit are faulty. Step 226 includes storing an event log in a memory device of the computing system 100, which may include one of the memory devices 108, a memory device of one of the processing units 102A-102n, the BIOS 104 (e.g., the memory device storing the BIOS firmware), a memory device of the peripheral devices 116 (e.g., a hard disk drive, a solid state drive, etc.), or in any other suitable location. The event log will generally include at least the identity of the socket of the undetectable processing unit, and the identity of any faulty interconnects that are electrically connected to the undetectable processing unit and/or the socket of the undetectable processing unit. In some cases, the event log includes a full accounting of each processor interconnect that is electrically connected to each of the processing units 102A-102n.

The example modular BIOS allows knowledge of how many CPUs are detectable and allows comparison with the order based on the product name information. The exact correct hardware configuration is known on the UPI. Thus, an 8S has 4 UPIs, a 4S has only 3 UPIs, and a modular 2S board only has 1 UPI on the respective motherboard. If there is an issue in degrading the UPI or some CPU is undetectable, a mismatch of the FRU product name will occur. For example, if an 8S has an 8S FRU product name, but the number of sockets is 4, it is known that the system under test has a KTI degradation issue and the SUT is a so-called degraded 4S. Based on previous debugging experiences with Intel, some of the root causes are difficult to determine as the CPU is non-detectable or the specific UPI port issue due to the BIOS only knowing the number of sockets in the end. In the case of a degraded 4S, if BIOS only knows the 4S, this is insufficient to know whether the CPU is not installed, a specific UPI port cable is broken, or a pcode issue based on a problem in the KTI training. The example method compares the number of sockets with the FRU product name to determine an abnormality in the hardware configuration. Thus, a degraded configuration can boot pass because the number of sockets is based on the port resources table. However, this does not allow a user to know the exact root cause of the degraded issue. Thus, a second feature is using the number of sockets and the FRU product name with the number of UPIs to determine whether the hardware configuration is expected. For example, if an 8S system under test with an 8S FRU product name actually detects only 4 CPUs, the 8S 4UPI configuration is the basis to report those disconnected UPI ports by bitmap to the Oemtype2 and to pass the critical error log on specific UPI ports to the SEL of the BMC. For the CPU, a bitmap for determining the CPU layout is available before the BIOS disables the CPU/UPI bitmap information for so-called KTI degradation and after this process. Based on this logic, these bitmaps may be used to have one diagram with the hardware configuration. If those disabled UPI ports are all close to specific sleds in modular design platform, it can be concluded that this issue is more related to specific modular sled. If those disabled CPUs are all close to a specific location of a CPU, it can be concluded that this issue is related to specific CPU that are not well-installed. Importantly, even is all CPUs and UPIs are detectable, then if some UPI port with UPI Link reduction (e.g., partial UPI lanes are dropped), it can be concluded there is a quality issue on a specific UPI cable. The vendor may then be informed to improve their quality control of the UPI cables. To summarize, the example method may facilitate issue triage and debugging on modular platforms.

Example resource tables for 4S and 2S configurations are shown in FIGS. 3A-3B. The resource tables in FIGS. 3A-3B may be used for 4S/2S porting that is compatible for a degraded 4S/2S config. Each of the resource tables in FIGS. 3A-3B show the bus porting for the CPUs of each sled and the MMIO-L porting for each of the CPUs. The modular product name is set as a default. The resource tables ensure the module is bootable for 32S/16S/8S/4S/2S with porting for Bus, MMIO-L, MMIO-H, and IO resources. A single modular product name may be used to control multiple modular SKUs, as the other features and porting may be determined from the number of sockets to access the proper resource table.

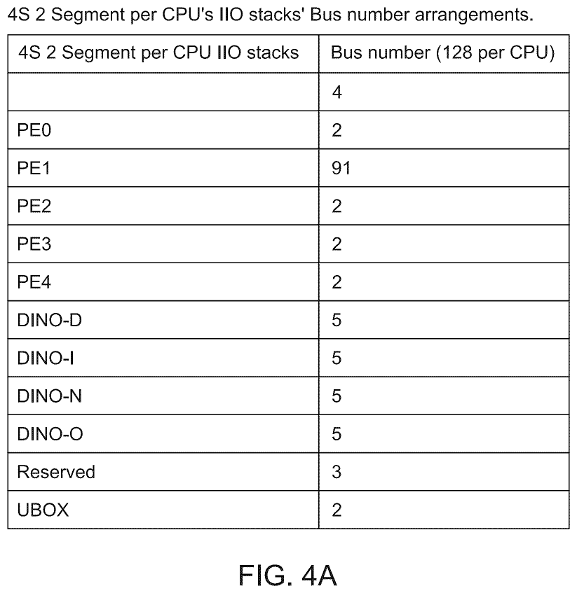

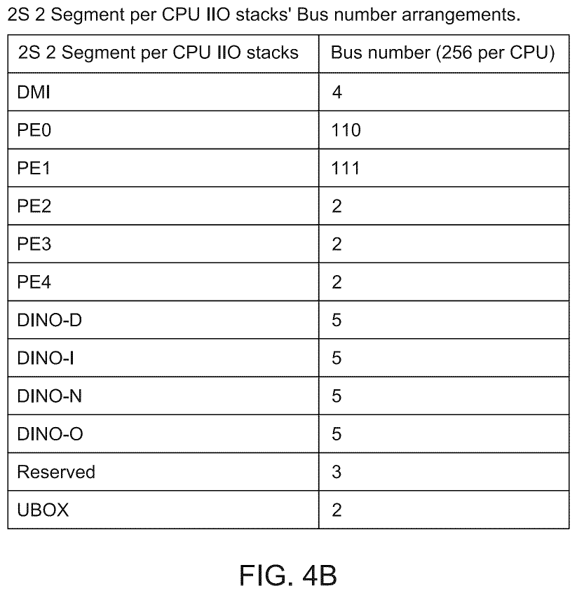

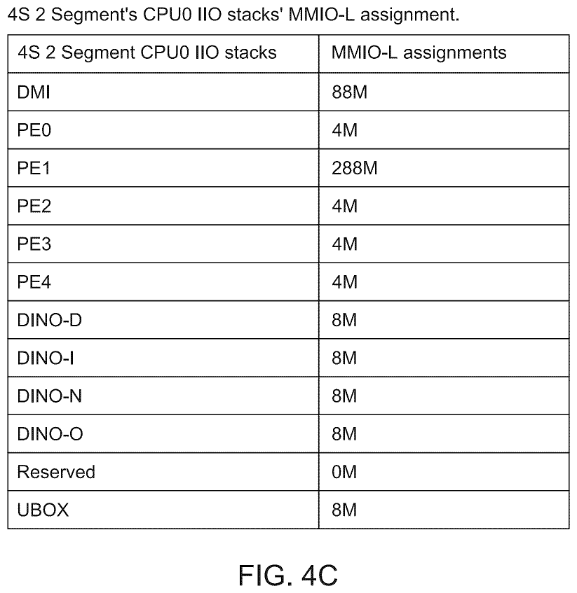

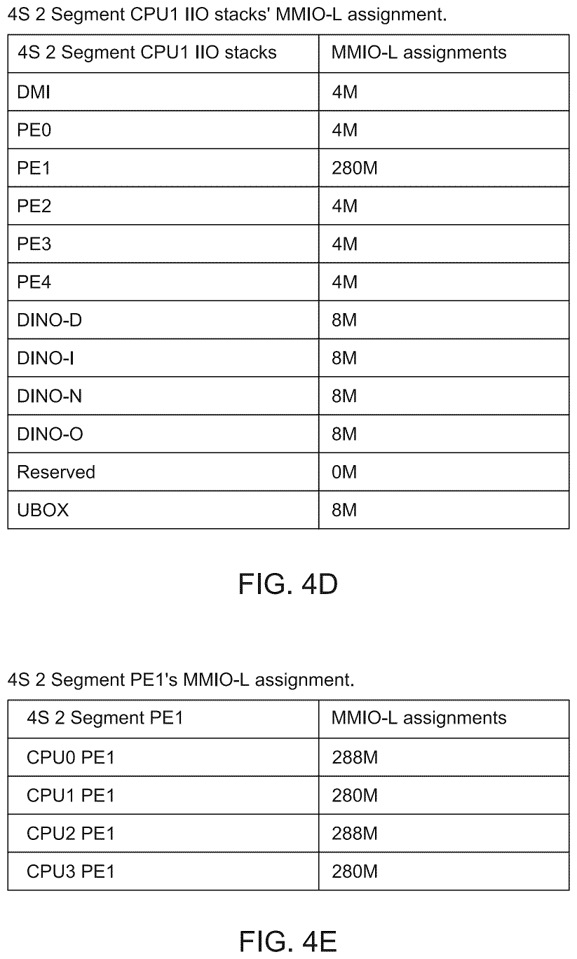

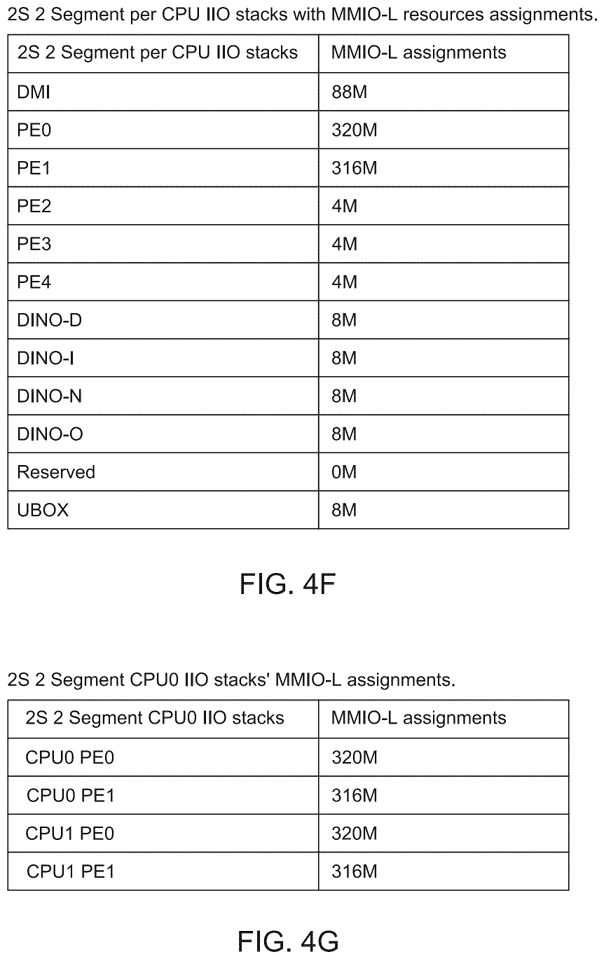

The example method may be used to handle all manufacturing situations of different modular assembly with a single product name. For example, an Intel EGS platform has 5 PCIe stable slots 0-4 designated as PE0-PE4. The corresponding bus resources for a corresponding bus are shown in a table in FIG. 4A. The table in FIG. 4A shows the bus number arrangements for a 4S 2 segment configuration as per IIO stacks of a CPU. Only a single PE (e.g., PE1) is assigned and thus has 91 bus numbers assigned. For the other unassigned PEs such as PE0, PE2, and PE3 which do not connect to PCIe devices, 2 bus numbers are still entered. For a PEx, 1 bus number at least must be assigned to support SR-IOV thus requiring 1 more bus number for each PEx. Thus, the other non-used PEs still need 2 bus assignments. To support a hot-plugged feature, an addition bus number assignment is required for a total of 3 bus assignments. In this example, the SR-IOV is enabled but hot-plugged is disabled thus only requiring 2 bus assignments. DINO is Intel's IP and requires 5 bus assignments for each totaling 20 bus assignments per CPU. The Reserved 3 bus assignment is due to segment enable, the last socket in the segment which is CPU1 or 3 (zero based). To let each CPUs have identical configuration, we port all CPUs with Reserved 3 bus assignments. The UBOX, also needs to have 2 bus assignments.

If the host detects the number of CPUs is two sockets only, the BIOS will automatically switch to the bus table shown in FIG. 4B. FIG. 4B is a bus number arrangement table for CPU IIO stacks for a 2S 2 segment configuration. In this configuration, each CPU has 256 bus assignments. In an example 2S M1 mother board fabrication, 2 pcs PCIe card must be tested, which means that PE0, PE1 are available for PCIe device resource assignments. In this example, PE0 is assigned for the 110 bus number, and PE1 is assigned for the 111 bus number. Both 2S M1 M/B manufacturing and 4S M3 server level configurations are all compatible for 1 BIOS FW to determine the numbers of CPUs. Even with KTI degradations, the 4S has some UPI issues causing CPU loss which is a so-called degraded 2S configuration. The 4S PE1 only needs 91 bus assignments, even when degraded to a degraded 2S. The PE1 still has 110 bus assignments, which is more than 4 S's PE1's 91 bus assignments. Thus, bus resources assignment by numbers of sockets can handle MFG configurations and KTI degradation cases.

FIG. 4C shows a table of 4S 2 Segment CPU0 MMIO-L assignments. In this example, the DMI needs at least 88M. For stable PCIe, PE1 needs 288M, and the other PE such as PE0, 2, 3, 4 are all assigned for 4M only. For DINO, each device needs to have 8M, so there are a total of 32M assigned. Reserved does not have a MMIO-L resources demand, so 0 M is assigned. For UBOX 8M resources are assigned.

FIG. 4D shows a table of 4S 2 Segment CPU1 MMIO-L assignments. For the example 4S 2 Segments, the CPU1 configuration is slightly different because there is no DMI in the table in FIG. 4D. However, for the same data structure, 4M still must be assigned to follow Intel's RC code rules.

FIG. 4E shows a table summarizing MMIO-L assignments for PE1 on the example 4S 2 Segments for each CPU. FIG. 4F is a MMIO-L resources assignment table for each CPU in a 2S 2 Segment. FIG. 4G shows a MMIO-L resources assignment table for CPU0 in a 2S 2 Segment.

Thus, for MMIO-L assignments the same logic underlying the bus assignments applies. For example, for PE1, 2S 2Segments only need to have 316M MMIO-L resources assignments. For 4S 2 Segments, 280 or 288M (based on the location of CPUs) are required. Thus, the 4S PE1 can use 280 M MMIO-L resources, and even the degraded 2S also has 320M assignments. Thus, this ensures the MMIO-L resources are not exceeding the max value and the present method allows handling a MFG 2S M1 configuration and a degraded 2S on MMIO-L assignments. The same logic for MMIO-L may be applied for MMIO-H, IO resources. Furthermore, although the above example relates to 2S and 4S, the principles may be applied for other configurations such as for 8S/16S/32S and other numbers of sockets.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A computing system comprising:
a baseboard management controller (BMC);
a plurality of processing units electrically connected to the BMC; and
a basic input output system (BIOS) chip having BIOS firmware stored thereon;
wherein during a start-up process of the computing system, one or more of the plurality of processing units is configured to execute the BIOS firmware to:
collect processing unit information;
determine, based at least in part on the processing unit information, a current configuration of the plurality of processing units; and
partition resources of the computing system among the plurality of processing units based at least in part on the current configuration of the plurality of processing units.

2. The computing system of claim 1, wherein the processing unit information includes a number of the plurality of processing units, an identification of a plurality of sockets of the computing system that each of the plurality of processing units is electrically connected to, a number of processing unit boards upon which the plurality of processing units is distributed, or any combination thereof.

3. The computing system of claim 1, wherein the resources of the computing system include at least (i) a plurality of memory devices, (ii) one or more chipsets, (iii) one or more peripheral devices, (iv) one or more bus segments electrically connecting the plurality of processing units to the plurality of memory devices, the one or more chipsets, and the one or more peripheral devices, or (v) any combination of (i)-(iv).

4. The computing system of claim 3, wherein partitioning the one or more memory devices of the computing system includes performing memory-mapped input/output to assign addressable space of the one or more memory devices to each of the plurality of processing units.

5. The computing system of claim 4, wherein in response to one of the plurality of processing units becoming undetectable during operation of the computing system, one or more other processing units of the plurality of processing units is configured to execute the BIOS firmware to cause addressable space assigned to the undetectable processing unit to be reassigned to a remainder of the plurality of processing units.

6. The computing system of claim 3, wherein partitioning the one or more bus segments includes assigning each of the one or more bus segments to one or more of the plurality of processing units.

7. The computing system of claim 6, wherein in response to one of the plurality of processing units becoming undetectable during operation of the computing system, one or more other processing units of the plurality of processing units is configured to execute the BIOS firmware to cause the bus segments assigned to the undetectable processing unit to be reassigned to a remainder of the plurality of processing units.

8. The computing system of claim 1, wherein the BIOS firmware stored on the BIOS chip includes a resource table, the resource table defining a partition plan of the resources of the computing system for each of a plurality of different configurations of the plurality of processing units.

9. The computing system of claim 1, wherein partitioning the resources of the computing system includes:
partitioning the resources according to a first partition plan in response to the current configuration of the plurality of processing units being a first configuration; and
partitioning the resources according to a second partition plan in response to the current configuration of the plurality of processing units being a second configuration,
wherein the second configuration includes (i) a different number of processing units than the first configuration, (ii) an identical number of processing units as the first configuration but a different set of sockets to which the processing units are electrically connected to, or (iii) an identical number of processing units as the first configuration but a different number of processing unit boards upon which the processing units are mounted.

10. The computing system of claim 1, wherein partitioning the resources of the computing system includes partitioning the resources according to a first partition plan based on the current configuration of the plurality of processing units, and wherein in response to one of the plurality of processing units becoming undetectable during operation of the computing system, one or more other processing units are configured to execute the BIOS firmware to cause the resources of the computing system to be partitioned according to a second partition plan based on an updated configuration of the plurality of processing units that does not include the undetectable processing unit, the second partition plan being different than the first partition plan.

11. The computing system of claim 1, wherein during a first portion of the start-up process, the one or more of the plurality of processing units is configured to execute the BIOS firmware to receive a first indication from the BMC that a variable number of processing units are electrically connected to the BMC, and wherein during a second portion of the start-up process, the one or more of the plurality of processing units is configured to execute the BIOS firmware to collect the processing unit information, determine the current configuration of the plurality of processing units, and partition the resources of the computing system.

12. The computing system of claim 11, wherein during the first portion of the start-up process, the one or more of the plurality of processing units is configured to execute the BIOS firmware to perform a power-on self-test (POST) routine.

13. The computing system of claim 1, further comprising a plurality of sockets and a plurality of interconnects electrically connecting each socket to at least one other socket, each of the plurality of processing units being electrically connected to one of the plurality of sockets, and wherein in response to one of the plurality of processing units becoming undetectable during operation of the computing system, one or more of the other processing units is configured to execute the BIOS firmware to:
determine which socket the undetectable processing unit is electrically connected to;
determine if any one or more of the plurality of interconnects electrically connected to the socket of the undetectable processing unit is faulty; and
store an event log in a memory device of the computing system, that the event log including an identity of the socket of the undetectable processing unit and an identity of any faulty interconnects electrically connected to the socket of the undetectable processing unit.

14. A method of operating a computing system that includes a baseboard management controller (BMC), a plurality of processing units electrically connected to the BMC, and a basic input output system (BIOS) chip having BIOS firmware stored thereon, the method comprising:
collecting processing unit information;
determining, based at least in part on the processing unit information, a current configuration of the plurality of processing units; and
partitioning resources of the computing system among the plurality of processing units based at least in part on the current configuration of the plurality of processing units.

15. The method of claim 14, wherein the processing unit information includes a number of the plurality of processing units, an identification of a plurality of sockets of the computing system that each of the plurality of processing units is electrically connected to, a number of processing unit boards upon which the plurality of processing units is distributed, or any combination thereof.

16. The method of claim 14, wherein the resources of the computing system include at least (i) a plurality of memory devices, (ii) one or more chipsets, (iii) one or more peripheral devices, (iv) one or more bus segments electrically connecting the plurality of processing units to the plurality of memory devices, the one or more chipsets, and the one or more peripheral devices, or (v) any combination of (i)-(iv).

17. The method of claim 14, wherein the BIOS firmware stored on the BIOS chip includes a resource table, the resource table defining a partition plan of the resources of the computing system for each of a plurality of different configurations of the plurality of processing units.

18. The method of claim 14, wherein partitioning the resources of the computing system includes:
partitioning the resources according to a first partition plan in response to the current configuration of the plurality of processing units being a first configuration; and
partitioning the resources according to a second partition plan in response to the current configuration of the plurality of processing units being a second configuration,
wherein the second configuration includes (i) a different number of processing units than the first configuration, (ii) an identical number of processing units as the first configuration but a different set of sockets to which the processing units are electrically connected to, or (iii) an identical number of processing units as the first configuration but a different number of processing unit boards upon which the processing units are mounted.

19. The method of claim 14, wherein partitioning the resources of the computing system includes partitioning the resources according to a first partition plan based on a current configuration of the plurality of processing units, and wherein the method further comprises:
determining that one of the plurality of processing units is undetectable;
determining an updated configuration of the plurality of processing units that does not include the undetectable processing unit; and
partitioning the resources of the computing system according to a second partition plan based on the updated configuration of the plurality of processing units, the second partition plan being different than the first partition plan.

20. The method of claim 14, wherein the computing system includes a plurality of sockets and a plurality of interconnects electrically connecting each socket to at least one other socket, each of the plurality of processing units being electrically connected to one of the plurality of sockets, and wherein the method further comprises, in response to one of the plurality of processing units becoming undetectable during operation of the computing system:
determining which socket the undetectable processing unit is electrically connected to;
determining if any of the plurality of interconnects electrically connected to the undetectable processing unit or the socket of the undetectable processing unit are faulty; and
storing an event log in a memory device of the computing system that includes an identity of the socket of the undetectable processing unit and an identity of any faulty interconnects electrically connected to the undetectable processing unit, the socket of the undetectable processing unit, or both.
